(19) United States
(12) Patent Application Publication
(10) Pub. No.: US 2015/0180929 A1
(43) Pub. Date: Jun. 25, 2015

(54) ALTERNATE PLAYBACK OF STREAMING MEDIA SEGMENTS

(71) Applicant: International Busineess Machines Corporation, Armonk, NY (US)

(72) Inventor: James G. McLean, Fuguay-Varina, NC (US)

(73) Assignee: International Business Machines Corporation, Armonk, NY (US)

(21) Appl. No.: 14/151,798

(22) Filed: Jan. 9, 2014

Related U.S. Application Data
(63) Continuation of application No. 14/133,881, filed on Dec. 19, 2013.

(51) Int. Cl. H04L 29/06

(52) U.S. Cl. CPC H04L 65/604

(57) ABSTRACT

Embodiments of the present invention provide a method, system and computer program product for the alternate playback of streaming media segments. In an embodiment of the invention, a method for alternate playback of streaming media segments includes receiving different segments of streaming media for playback in sequence in a media player executing in memory of a playback device and rejecting playback of one of the different segments during playback of the one of the different segments. The method also includes selecting an alternate segment for playback in the media player in place of the rejected one of the different segments. Finally, the method includes playing back in the media player the alternate segment in place of the rejected one of the different segments, and subsequently playing back in the media player a next one of the different segments in the sequence.

### BACKGROUND OF THE INVENTION

1. Field of the Invention

The present invention relates to streaming media playback and more particularly to selection of streaming media segments for playback in a computer communications network.

Description of the Related Art

The advent of the Internet has given rise to new modes of media distribution facilitating the wide scale dissemination of audiovisual material. Streaming media is one such mode of distributing audiovisual material in which portions of the audiovisual material are transmitted over a computer communications network and received in a consuming computing device. While an initial portion of the received audiovisual material is played back immediately in a streaming media player executing in the computing device, remaining portions are buffered in the memory of the computing device until such time as it is necessary to play back the buffered portions.

Unlike the static playback of media resident in fixed storage of a computing device, when streaming media, less flexibility exists in respect to the manner in which the playback of the audiovisual material occurs. In the static case, the end user can fast forward or fast reverse to any portion of the audiovisual material skipping at will one or more frames of the audiovisual material. However, in the streaming case, the end user cannot readily skip material not yet received and buffered and further, in some cases, content playback is restricted by the content provider irrespective of the underlying technical limitations of streaming media. Furthermore, in some broadcast-streaming contexts such as satellite radio, skipping segments is not feasible as there is no possibility of moving forward in time to content that has not yet been broadcast.

Of note, streaming media often is provided in the form of different audiovisual segments. For example, when streaming media is a sequence of musical performances, the entirety of the streaming media can consist of different segments representing individual songs, segments of songs, and interstitial content. As another example, when streaming media is a sequence of video programming including substantive content interspersed with commercial advertisements, each commercial advertisement can be a separate segment, as can one or more portions of the substantive content. Plainly, it often is the desire of the end user to skip some segments of streaming media in favor of alternate segments without distraction or disruption to the playback of the streaming media.

### BRIEF SUMMARY OF THE INVENTION

Embodiments of the present invention address deficiencies of the art in respect to streaming media and provide a novel and non-obvious method, system and computer program product for the alternate playback of streaming media segments. In an embodiment of the invention, a method for alternate playback of streaming media segments is provided. The method includes receiving different segments of streaming media for playback in sequence in a media player executing in memory of a playback device and rejecting playback of one of the different segments during playback of the one of the different segments. The method also includes selecting an alternate segment for playback in the media player in place of the rejected one of the different segments. Finally, the method includes playing back in the media player the alternate segment in place of the rejected one of the different segments, and subsequently playing back in the media player a next one of the different segments in the sequence.

In one aspect of the embodiment, the alternate segment is selected from a set of alternate segments which are stored in fixed storage of the computer or in fixed storage of a remote computing system. In another aspect of the embodiment, the alternate segment is selected based upon a playback time of the alternate selection most closely matching a remaining playback time of the rejected one of the different segments. In this regard, a buffer segment can be played back after playback of the alternate segment and before the next one of the different segments. The buffer segment has a playback time comparable to a difference between the remaining playback time and the playback time of the alternate selection.

In another embodiment of the invention, a streaming media data processing system is provided. The system includes a media player executing in memory of a computer and communicatively coupled to a streaming media server over a computer communications network. The media player receives from the streaming media server different segments of streaming media for playback in sequence, for example audio or video. The system also includes an alternate media playback module executing in the memory of the computer. The module includes program code enabled to reject playback of one of the different segments during playback of the one of the different segments, to select an alternate segment for playback in the media player in place of the rejected one of the different segments, and to direct the media player to play back the alternate segment in place of the rejected one of the different segments. Thereafter, playback of a next one of the segments in the sequence can occur.

In yet another embodiment of the invention, a streaming media data processing system is provided. The system includes a media player executing in memory of a computer and receiving streaming media over a broadcast channel such as a satellite radio service. The media player receives from the broadcast service a primary media stream that includes different segments of streaming media for playback in sequence, for example audio or video. The system also includes an alternate media playback module executing in the memory of the media player. The module includes program code enabled to reject playback of one of the different segments of the primary media stream during playback of the primary media stream, to select an alternate segment for playback in the media player in place of the rejected one of the different segments, to direct the media player to playback the alternate segment in place of the rejected one of the different segments, and to rejoin the primary media stream following playback of the alternate selection.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for the alternate playback of streaming media segments;

FIG. 2 is a schematic illustration of a data processing system configured for the alternate playback of streaming media segments; and,

FIG. 3 is a flow chart illustrating a process for the alternate playback of streaming media segments.

### DETAILED DESCRIPTION OF THE INVENTION

Embodiments of the invention provide for the alternate playback of streaming media segments. In accordance with an embodiment of the invention, streaming media can be streamed to a client computing device including multiple different segments to be played sequentially upon receipt in the client computing device. Responsive to detecting a rejection of one of the different segments, an alternate one of the segments can be selected for playback in the client computing device in lieu of the rejected one of the different segments. For instance, the alternate one of the segments can be selected according to a duration of playback of the alternate one of the segments known to be shorter in time than the rejected one of the different segments.

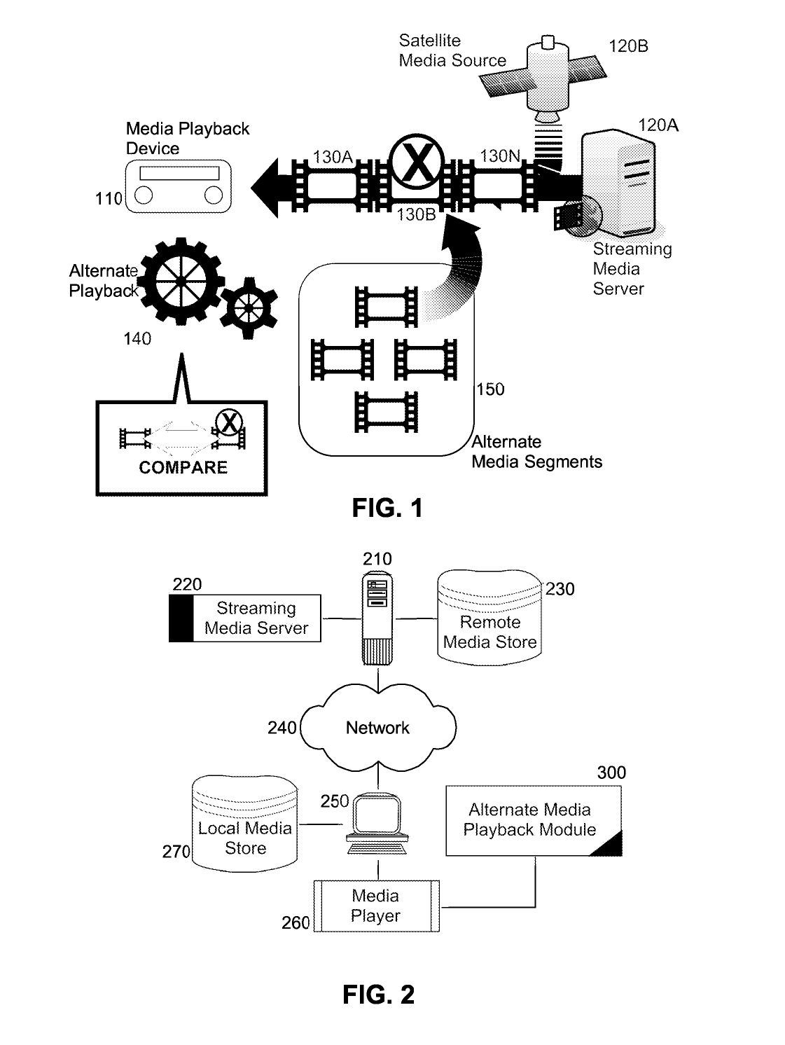

In further illustration, FIG. 1 pictorially shows a process for the alternate playback of streaming media segments. As shown in FIG. 1, a streaming media source 120A, 120B such as a satellite radio media source 120B or streaming media server 120A can stream a multi-segment media stream 130A, 130B, 130N for viewing in a media playback device 110. During the playback of a selected one of any of the segments 130A, 130B, 130N, for example segment 130B, an end user can reject the continued playback of one of the segments 130A, 130B, 130N in favor of the playback of a different media segment selected from amongst a set of alternate media segments 150.

In this regard, alternate playback logic 140 can compare instances of the alternate media segments 150 in order to identify a particular one of the alternate media segments 150 most suitable to playback instead of the rejected one of the segments 130A, 130B, 130N. In particular, a particular one of the alternate media segments 150 having a playback duration which is most closely aligned with a remaining time of playback of the rejected one of the segments 130A, 130B, 130N can be identified and played back in lieu of the rejected one of the segments 130A, 130B, 130N. Optionally, to the extent that the playback duration of the particular one of the alternate media segments 150 is less than the remaining time of the playback of the rejected one of the segments 130A, 130B, 130N, a buffer segment can be selected. The buffer segment can have a playback duration comparable to the difference between the playback duration of the particular one of the alternate media segments 150 and the remaining time of the playback of the rejected one of the segments 130A, 130B, 130N.

The process described in connection with FIG. 1 can be implemented within a media streaming data processing system. In yet further illustration, FIG. 2 schematically shows a data processing system configured for the alternate playback of streaming media segments. As shown in FIG. 2, a host computing system 210 can be provided and can include one or more computers, each with memory and at least one processor. The host computing system 210 can support the operation of a streaming media server 220 configured to stream media disposed in a remote media store 230 to a media player 260 executing in a client computer 250 over computer communications network 240.

The client computer 250 can include memory and at least one processor. Further, the client computer 250 can support the execution of the media player 260 and the media player 260, in turn, can be coupled to an alternate media playback module 300 also executing in the memory of the client computer 250. The alternate media playback module 300 can include computer program code that when executing in the memory of the client computer 250, allows during the playback of a segment of streaming media in the media player 260, the rejection of the continued playback of the segment in favor of an alternate segment disposed either in the remote media store 230 or a local media store 270 of alternate media segments.

In one aspect of the embodiment illustrated in FIG. 2, the program code of the alternate media playback module 300 can select the alternate segment based upon a comparison of the playback time of the alternate segment and a remaining duration of time for the rejected segment. Specifically, once a remaining duration of time is determined for the rejected segment, an alternate segment in the local media store 270, or optionally the remote media store 230, can be selected according to a duration of time for playback of the alternate segment that is closest to the remaining duration of time for the rejected segment.

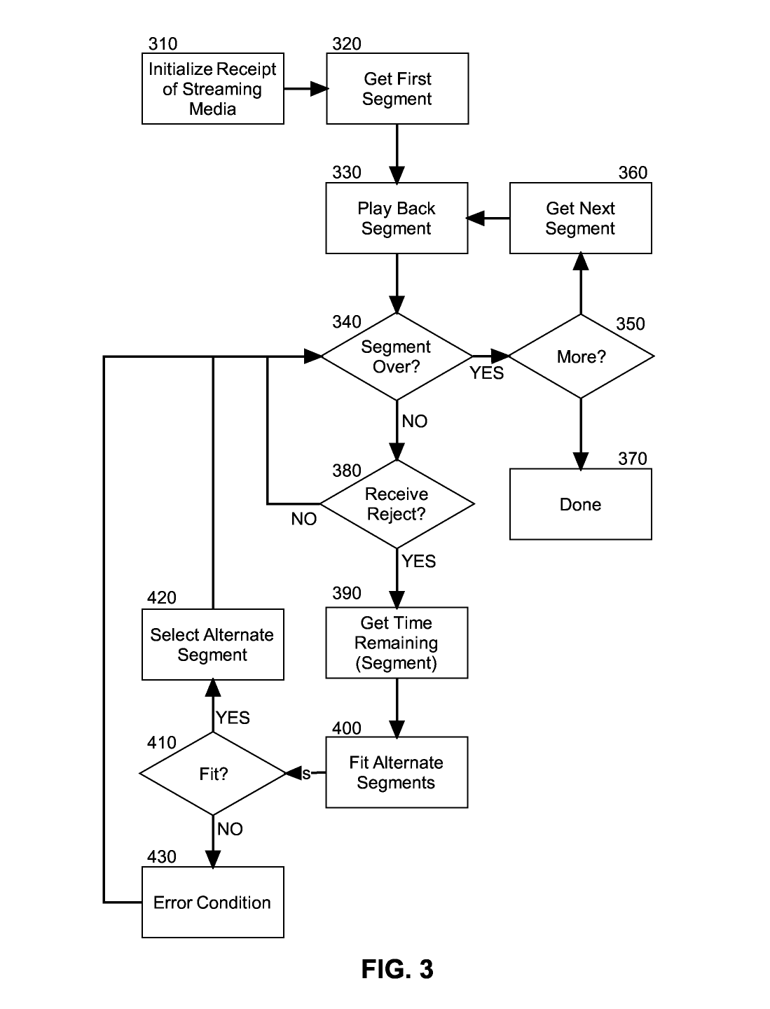

In even yet further illustration of the operation of the alternate media playback module 300, FIG. 3 is a flow chart illustrating a process for the alternate playback of streaming media segments. Beginning in block 310, a streaming media player can be initialized to receive streaming media in the form of different media segments from a streaming media server. In block 320, a first streaming media segment can be received for playback in the media player and in block 330 the media segment can begin playback. In decision block 340, it can be determined whether or not the playback of the segment has completed. If so, in decision block 350 it can be determined whether or not additional segments remain to be played back. If so, in block 360 a next segment can be retrieved and the segment can be played back in block 330. Otherwise the process can end in block 370.

In decision block 340, if it is determined that the segment is not yet fully played back, in decision block 380 it can be determined whether or not a selection to reject the segment has been received. If so, in block 390 a remaining duration of time to play back the rejected segment can be determined. Thereafter, in block 400 a selection of alternative segments can be analyzed to identify a segment with a playback time closest in value to the remaining duration of time to play back the rejected segment. In decision block 410, it can be determined whether or not one of the alternate segments in the selection have a playback time within a threshold value of the determined remaining duration of time. If not, an error condition can be presented in block 430 and the rejected segment can continue playback. Otherwise, in block 420 the alternate segment determined to have a playback time within the threshold value of the determined remaining duration of time can be selected for playback and the process can return to decision block 340.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for alternate playback of streaming media segments, the method comprising:
receiving from a streaming media source different segments of streaming media for playback in sequence in a media player executing in memory of a playback device;
rejecting playback of one of the different segments during playback of the one of the different segments;
selecting an alternate segment for playback in the media player in place of the rejected one of the different segments; and,
playing back in the media player the alternate segment in place of the rejected one of the different segments, and subsequently playing back in the media player a next one of the different segments in the sequence.

2. The method of claim 1, wherein the streaming media source is satellite radio.

3. The method of claim 2, wherein the set of alternate segments are stored in fixed storage of the playback device.

4. The method of claim 2, wherein the set of alternate segments are stored in fixed storage of a remote computing system.

5. The method of claim 1, wherein the alternate segment is selected based upon a playback time of the alternate selection most closely matching a remaining playback time of the rejected one of the different segments.

6. The method of claim 5, wherein a buffer segment is played back after playback of the alternate segment and before the next one of the different segments, the buffer segment having a playback time comparable to a difference between the remaining playback time and the playback time of the alternate selection.

7-20. (canceled)
